(19) United States
(12) Patent Application Publication
(10) Pub. No.: US 2022/0077713 A1
(43) Pub. Date: Mar. 10, 2022

(54) METHOD AND SYSTEM FOR POWERING EMBEDDED DEVICES LOCATED AT A LIVE EVENT

(71) Applicant: Spektacom Technologies Private Limited, Bangalore (IN)

(72) Inventors: Anil Kumble, Bangalore (IN); Harsha Chaturvedi, Bangalore (IN)

(21) Appl. No.: 17/431,062

(22) PCT Filed: Feb. 13, 2020
(86) PCT No.: PCT/IB2020/051172

§ 371 Date: Aug. 13, 2021

(30) Foreign Application Priority Data
Feb. 13, 2019 (IN) 201941005695

(51) Int. Cl. H02J 9/06; H02J 7/00

(52) U.S. Cl. CPC H02J 9/06; H02J 7/0013

(57) ABSTRACT

The invention provides methods and system for powering of embedded devices located at a live event for capturing data. A first energy source is identified for providing power to at least one component of an embedded device. A status of the identified first energy source is then determined. The status may be one of a functional and non-functional status. In an event the status of the first energy source is determined to be non-functional, a second energy source to provide power to at least one component of the embedded device is automatically activated. The status of the first energy source is determined to be non-functional based on the amount of energy in the first energy source, the time of the day, the operating status of the first energy source. Thereafter, power to the at least component of the embedded device is provided by the second energy source.

### FIELD OF THE INVENTION

The present invention generally relates to the field of powering devices, and more particularly, to a method and system for powering embedded devices located at a live event.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

During a live event, several devices are embedded at various locations and placed in various articles, which are used to collect data from the live event. For example, in a sports event, the embedded devices can be present inside equipment and/or articles used by players. In a music concert, the embedded devices can be present inside musical instruments and/or articles used by performers. These embedded devices are used to collect data in real time to help get telemetric and other relevant data to a cloud server. It has been observed that the biggest challenge in utilizing such embedded devices is the requirement of sufficient source of power for these devices.

Conventional embedded devices existing in market today are power hungry and require bigger source of power in order to operate for entire duration of a live event. In instances, where live events are of longer duration in nature such as a test cricket match, it becomes extremely challenging to meet power requirements of such embedded devices. Furthermore, with increasing demand of data collection to cover a live event from different perspectives, embedded devices are installed with additional circuitries to enable capturing of live events from different angles with additional data. These embedded devices are also often designed with additional circuitry to perform computation or processing of the data collected/captured by the device. However, inclusion of such additional circuitries impacts the power consumption demands of the embedded devices and the embedded devices run out of power quickly

Conventionally, these embedded devices are powered by batteries of the articles in which these embedded devices are located. For example, in smart bats which are used in cricket, a single battery is inserted into a bat which is used to power an impact sensor (embedded device). Therefore, the single battery in the embedded device depletes faster due to high-power consumption and is completely discharged within a few hours. Hence, important data to be captured may be missed when the device's power runs out.

In view of these and other existing limitations, there arises an imperative need to provide a solution to overcome the limitations of prior existing solutions and to provide a more reliable, long lasting and efficient mechanism of powering embedded devices located at a live event for capturing data.

### SUMMARY

This section is provided to introduce certain objects and aspects of the present disclosure in a simplified form that are further described below in the detailed description. This summary is not intended to identify the key features or the scope of the claimed subject matter. In order to overcome at least a few problems associated with the known solutions as provided in the previous section, an object of the present disclosure is to provide a method and system to which facilitates power solutions for embedded devices used to capture data at live events. It is another object of the present invention to provide a system and method which can provide uninterrupted power to an embedded device for a longer time duration. It is yet another object of the invention to provide multiple sources of power for a reliable and long-lasting solution. It is yet another object of the invention to provide a secondary energy source when the primary energy source is non-functional. It is yet another object of the invention to replenish one energy source using another energy source in the embedded device.

In order to achieve the afore-mentioned objectives, the present disclosure provides a method for powering embedded devices located at a live event for capturing data, wherein the method begins with identifying a first energy source for providing power to at least one component of an embedded device. A status of the identified first energy source is then determined. The status is determined dynamically or periodically. The status may be one of a functional and non-functional status. A functional status is determined when the first energy source is operational, and/or the first energy source is powering the at least one component of the embedded device. In an event the status of the first energy source is determined to be non-functional, a second energy source to provide power to at least one component of the embedded device is automatically activated. The status of the first energy source is determined to be non-functional based on the amount of energy in the first energy source, the time of the day, the operating status of the first energy source. Thereafter, power to the at least component of the embedded device is provided by the second energy source.

Another aspect of the present disclosure relates to a system for powering embedded devices located at a live event for capturing data, wherein the system comprises a first energy source, a second energy source and at least one processing unit. The first energy source is configured to provide power to at least one component of an embedded device. The second energy source is connected to the first energy source and is also configured to provide power to the at least one component of the embedded device. The processing unit is configured to identifying a first energy source for providing power to at least one component of an embedded device. The processing unit is also configured to determine a status of the first energy source. The processing unit is configured to determine the status dynamically or periodically. The status may be one of a functional and non-functional status. A functional status is determined by the processing unit when the first energy source is operational, and/or the first energy source is powering the at least one component of the embedded device. In an event the status of the first energy source is determined to be non-functional by the processing unit, the processing unit is configured to automatically activate the second energy source to provide power to at least one component of the embedded device.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components.

FIG. 1 illustrates an architecture of a system [100] for powering embedded devices located at a live event for capturing data, in accordance with exemplary embodiments of the present disclosure.

FIG. 2 illustrates an exemplary method flow diagram [200] depicting a method of powering embedded devices located at a live event for capturing data, in accordance with exemplary embodiments of the present disclosure.

FIG. 3 illustrates an exemplary use case scenario [300] of powering embedded devices located at a live event for capturing data, in accordance with exemplary embodiments of the present disclosure.

### DETAILED DESCRIPTION

In the following description, for the purposes of explanation, various specific details are set forth in order to provide a thorough understanding of embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The present disclosure discloses a method and system for providing reliable and efficient powering of embedded devices located at a live event for capturing data. The present invention discloses identifying a first energy source for providing power to at least one component of an embedded device. A status of the identified first energy source is then determined. The status may be determined dynamically or periodically. The status may be one of a functional and non-functional status. A functional status is determined when the first energy source is operational, and/or the first energy source is powering the at least one component of the embedded device. In an event the status of the first energy source is determined to be non-functional, a second energy source to provide power to at least one component of the embedded device is automatically activated. The status of the first energy source is determined to be non-functional based on the amount of energy in the first energy source, the time of the day, the operating status of the first energy source. Thereafter, power to the at least component of the embedded device is provided by the second energy source.

As used herein, the “embedded device” refers to any electrical, electronic, electromechanical and computing device which is configured to capture data at a live event. The embedded device may include, but not limited to, a camera, a sensor, a voice recorder, a bat with sensing electronics, and a mobile phone and any such device obvious to a person skilled in the art.

As used herein, a “processing unit” or “processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

The invention is further explained in detail below with reference now to the diagrams.

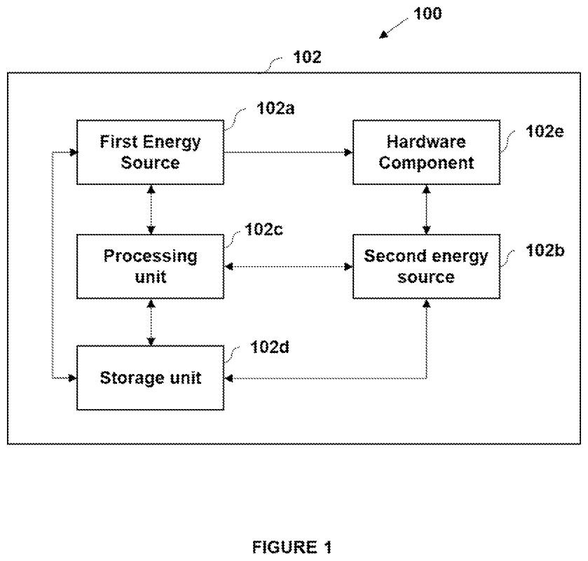

Referring to FIG. 1, an exemplary architecture of a system [100] for powering at least one embedded device [102] located at a live event for capturing data, is disclosed in accordance with exemplary embodiments of the present invention. As shown in FIG. 1, the system [100] comprises of at least one embedded device [102] comprising of a first energy source [102a], a second energy source [102b], a processing unit [102c], a storage unit [102d] and at least one component [102e] wherein all the components are assumed to be connected to each other unless otherwise indicated below.

In a preferred embodiment, the invention encompasses that all the components of the system [100] may be a part of the embedded device [102]. In another embodiment, some of the components of the system [100] may be a part of the embedded device [102] connected to the other components via a network. As used herein, the network may be a wired or wireless network. For example, the processing unit [102c] may be a separate component connected to the embedded device [102] via a wireless network.

Further, although only one embedded device [102] is shown in the figure, it will be appreciated by those skilled in the art that the invention encompasses multiple such devices as may be necessary to implement the invention. Moreover, although only one first energy source [102a], a second energy source [102b], a processing unit [102c], a storage unit [102d] and at least one component [102e] is shown in the present disclosure, however, it will be appreciated by those skilled in the art that the invention encompasses multiple such units as may be necessary to implement the invention.

The first energy source [102a] of the present invention is an energy source configured to provide power to at least one component [102e] of the embedded device [102]. The first energy source [102a] may include at least one lithium ion battery, solar battery power source, hybrid quartz crystal oscillators or any other source for providing energy/power to an electrical component. For example, the first energy source [102a] may be Li-ion batteries. The invention encompasses that the first energy source [102a] may be the primary source of power to at least one component [102e] of the embedded device [102].

The second energy source [102b] of the present invention is also an energy source configured to provide power to at least one component [102e] of the embedded device [102]. The second energy source [102b] may include at least one lithium ion battery, solar battery power source, hybrid quartz crystal oscillators or any other source for providing energy/power to an electrical component. For example, the second energy source [102b] may be a solar power battery source, using solar energy to provide power to the at least one component [102e]. The invention encompasses that the second energy source [102b] is connected to the first energy source [102a]. For example, the second energy source [102b] of a solar power battery source may be connected to the first energy source [102a] of Li-ion batteries. The connection between the first energy source [102a] and the second energy source [102b] may be an intrinsic connection or an extrinsic connection. In an embodiment, the second energy source [102b] may be connected to the edge device

using a detachable connection to enable detaching of the second energy source [102b] from the embedded device [102]. The invention encompasses that the second energy source [102b] may be the secondary source of power to at least one component [102e] of the embedded device [102].

The invention encompasses that the second energy source [102b] is also configured to provide energy/power to the first energy source [102a]. For example, the second energy source [102b] may also be configured to recharge the first energy source [102a]. For example, the second energy source [102b] of a solar battery power source may be configured to recharge the first energy source [102a] of Li-ion batteries.

The invention encompasses that there may be a third energy source (not shown) in the system [100] wherein the is also an energy source configured to provide power to at least one component [102e] of the embedded device [102]. The third energy source may include at least one lithium ion battery, solar power battery source, hybrid quartz crystal oscillators or any other source for providing energy/power to an electrical component. For example, the third energy source may be hybrid quartz crystal oscillators. In an embodiment, the third energy source may be connected to the first energy source [102a], the second energy source [102b] and the at least one component [102e]. In another embodiment, the third energy source may be connected to the first energy source [102a] and the second energy source [102b]. For example, the third energy source may be connected to the solar battery power source and the Li-ion batteries in the system [100]. The invention encompasses that the third energy source is also configured to provide energy/power the first energy source [102a] and/or the second energy source [102b]. For example, the third energy source may be configured to recharge the first energy source [102a] and/or the second energy source [102b]. For example, the third energy source may be configured to recharge the solar battery power source and the Li-ion batteries.

The processing unit [102c] of the present invention is configured to identify the first energy source [102a] to provide power to at least one component [102e] of the embedded device [102]. For example, the processing unit [102c] may identify the first energy source [102a] to be the Li-ion batteries to provide power to at least one component [102e] of the embedded device [102]. In another example, the processing unit [102c] may identify the first energy source [102a] to be a solar battery power source to provide power to at least one component [102e] of the embedded device [102].

The processing unit [102c] is also configured to determine a status of the first energy source [102a]. The processing unit [102c] is also configured to determine the status of the first energy source [102a] dynamically or periodically. In a preferred embodiment, the processing unit [102c] is also configured to determine a status of the first energy source [102a] dynamically. For example, the processing unit [102c] may be configured to determine a status of the first energy source [102a] such as Li-ion batteries after every eight hours to determine if the batteries are completely discharged.

The invention encompasses that the status may be determined to be one of a functional and non-functional status. A functional status is determined by the processing unit [102c] when the first energy source [102a] is operational, and/or the first energy source is powering the at least one component of the embedded device. As used herein, “operational” means that the first energy source [102a] is working, operating properly and providing power with the standard efficiency levels. The invention encompasses that the processing unit [102c] may be configured to determine an operational status based on the determination of certain parameters of the first energy source [102a]. For example, the processing unit [102c] may determine if the first energy source [102a] is operational by checking all the components of the first energy source [102a]. The processing unit [102c] is also configured to determine a functional status for the first energy source [102a] when the first energy source [102a] is providing power to at least one component [102e].

The processing unit [102c] is configured to determine the status of the first energy source [102a] to be non-functional based on at least one of the amount of energy in the first energy source [102a], the time of the day, the operating status of the first energy source [102a]. For example, the processing unit [102c] may determine the status of the first energy source [102a] of Li-ion battery's to be non-functional when the batteries have been completely depleted. In another example, the processing unit [102c] may determine the status of the first energy source [102a] of solar power battery source to be non-functional during night. In yet another example, the processing unit [102c] may determine the status of the first energy source [102a] of solar battery power source to be non-functional when the solar power battery source has broken down or isn't functioning properly.

The processing unit [102c] is further configured to automatically activate the second energy source [102b] to provide power to at least one component of the embedded device in an event the status of the first energy source [102a] is determined to be non-functional by the processing unit [102c]. As used herein, the “activation” of the second energy source [102b] means triggering the second energy source [102b] to provide power to at least component [102e] of the embedded device [102].

The processing unit [102c] is further configured to recharge at least one of the first energy source [102a] and the second energy source [102b]. In an embodiment, the processing unit [102c] is configured to recharge the first energy source [102a] or the second energy source [102b] using the energy stored in the storage unit [102d]. In another embodiment, the processing unit [102c] is further configured to recharge the first energy source [102a] using the second energy source [102b].

The storage unit [102d] of the present invention is configured to store energy from at least one of the first energy source [102a] and the second energy source [102b]. The stored energy made be used by the first energy source [102a] or the second energy source [102b] to recharge.

The invention encompasses that the storage unit [102d] may include, but not be limited to, conventional chemical battery storage and capacitors to store the energy. The energy may be stored electrostatically. In a preferred embodiment, the storage unit [102d] may include ultra-capacitors. The use of ultra-capacitors strengthens the system [100] of the present invention thereby making it robust to be used in embedded devices [102]. Furthermore, the ultra-capacitors get charged quickly as compared to conventional batteries irrespective of ambient temperatures, thereby making the system [100] useful in situations where longer duration live event needs to be captured.

The at least one component [102e] of the present invention may be any component of the embedded device [102] configured to capture data of a live event. The at least one component [102e] may include but not be limited to a transmitter, a receiver, a memory unit, a buffer, electrical conductors and at least one sensor on the embedded device [102].

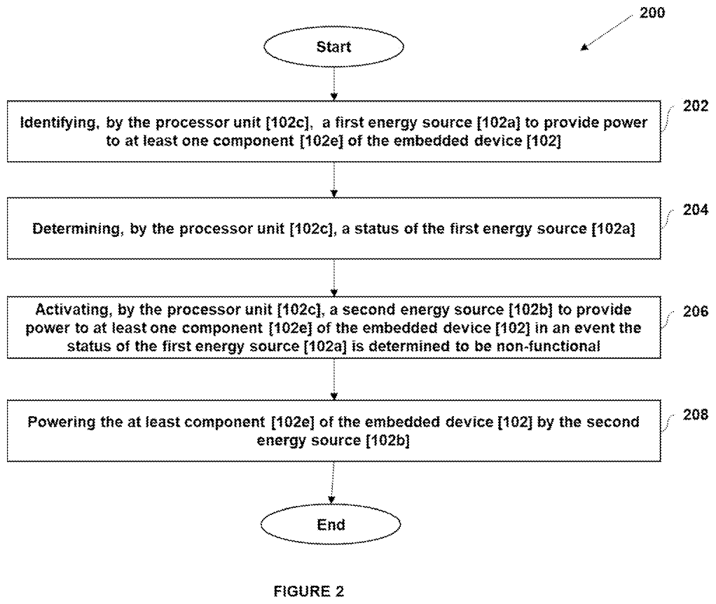

Now, referring to FIG. 2, an exemplary method flow diagram [200] depicting a method of powering at least one embedded device [102] located at a live event for capturing data, in accordance with exemplary embodiments of the present disclosure. The method [200] commences at step 200. At step 202, a first energy source [102a] is identified to provide power to at least one component [102e] of the embedded device [102]. In an embodiment, the first energy source [102a] is identified by the processing unit [102c] to be the default/primary mode of powering the embedded device [102] when the embedded device [102] is switched on. In an embodiment, the first energy source [102a] may be identified by the processing unit [102c] to be mode of powering the embedded device [102] at that point of time.

At step 204, a status of the first energy source [102a] is determined by the processor unit [102c]. The invention encompasses that the status may be determined dynamically or periodically. For example, the status of the first energy source [102a] is determined by the processor unit [102c] after every 5 hours. In another example, the status of the first energy source [102a] may be determined by the processor unit [102c] dynamically.

The invention further encompasses that the status may be determined to be one of a functional and non-functional status. A functional status is determined by the processing unit [102c] when the first energy source [102a] is operational, and/or the first energy source is powering the at least one component [102e] of the embedded device [102]. The invention encompasses determining an operational status based on the determination of certain parameters of the first energy source [102a]. For example, the first energy source [102a] may be determined to be operational by checking all the components of the first energy source [102a]. The functional status for the first energy source [102a] may also be determined when the first energy source [102a] is providing power to at least one component [102e].

The invention further encompasses determining the status of the first energy source [102a] to be non-functional based on at least one of the amount of energy in the first energy source [102a], the time of the day, the operating status of the first energy source [102a]. For example, the status of the first energy source [102a] of Li-ion battery's may be determined to be non-functional when the batteries have been completely discharged. In another example, the status of the first energy source [102a] of solar power battery source may be determined to be non-functional during night. In yet another example, the status of the first energy source [102a] of quartz battery power source to be non-functional when the quartz battery power source isn't functioning properly.

At step 206, a second energy source [102b] is activated by the processor unit [102c] to provide power to at least one component [102e] of the embedded device [102] in an event the status of the first energy source [102a] is determined to be non-functional. For example, in an event the Li-ion batteries are determined to be discharged completely, the status of the Li-ion batteries as the first energy source [102a] is determined to be non-functional.

At step 208, the at least component [102e] of the embedded device [102] is powered by the second energy source [102b]. For example, in an event the Li-ion batteries are determined to be non-functional, a sensor of the embedded device [102] may be powered by the solar power battery source.

The invention further encompasses storing, by at least one of the first energy source [102a] and the second energy source [102b], energy in a storage unit [102e]. In a preferred embodiment, the storage unit [102d] may include, but not be limited to, ultra-capacitors to strengthen the system [100] and making it more efficient as compared to conventional batteries irrespective of ambient temperatures.

The invention further encompasses storing energy in a storage unit [102e] for recharging at least one of the first power source [102a] and the second power source [102b]. In an embodiment, the energy stored in a storage unit [102e] may be used to provide power to the sensor in the sticker [102e].

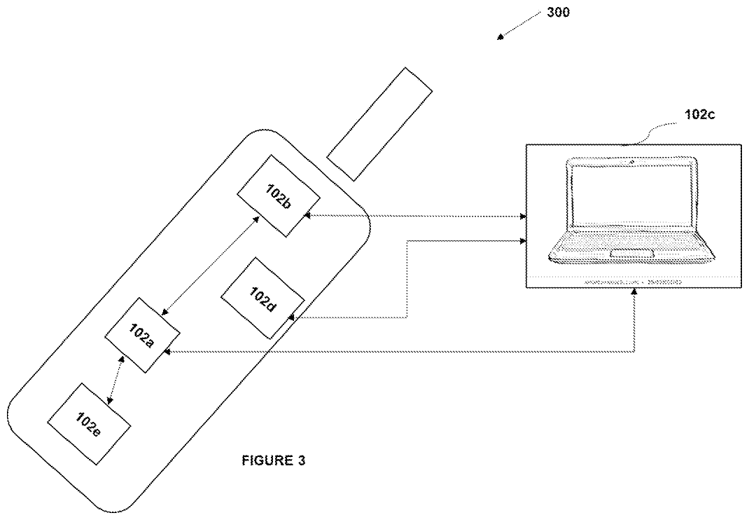

Referring to FIG. 3, an exemplary use case [300], in accordance with exemplary embodiment of the present disclosure is shown.

The shown exemplary use case indicates a first energy source [102a], a second energy source [102b] and the storage unit [102d] in an embedded device [102] such as a bat connected to the processing unit [102c] using a connection, such as a wireless connection. The present invention commences when the embedded device [102] is powered on. When the embedded device [102], such as a bat, is powered on, a first energy source [102a] is identified to provide power to at least one component [102e], such as a sensor in a sticker, of the embedded device [102]. The first energy source [102a] that is identified by the processing unit [102c] may be the Li-ion batteries in the embedded device [102], bat.

The invention further encompasses dynamically determining the status of the Li-ion batteries [102a] are a time period, for example eight hours. The status of the Li-ion batteries is dynamically determined by the processor unit [102c]. The status determined is one of a functional and non-functional status. A functional status is determined by the processing unit [102c] when the Li-ion batteries are operational, and/or the Li-ion batteries are powering the sensor in a sticker [102e] on the bat [102]. The invention encompasses determining an operational status based on the determination of certain parameters of Li-ion batteries [102a]. For example, the Li-ion batteries [102a] may be determined to be operational by checking all the components of the Li-ion batteries [102a]. The functional status for the Li-ion batteries [102a] may also be determined when the Li-ion batteries [102a] is providing power to the sensor in the sticker [102e].

The invention further encompasses that the dynamically determined status of the Li-ion batteries [102a] to be non-functional based on at least one of the amount of energy in the Li-ion batteries [102a], the time of the day and the operating status of the Li-ion batteries [102a]. For instance, the status of the Li-ion batteries [102a] may be determined to be non-functional when the batteries have been completely discharged. In another instant, the status of the Li-ion batteries [102a] may be determined to be non-functional when the batteries aren't functioning properly.

In an event the status of the Li-ion batteries [102a] is determined to be non-functional, a solar battery power source [102b] is activated by the processor unit [102c] to provide power to sensor in a sticker [102e] of the bat [102]. For example, in an event the Li-ion batteries are determined to be discharged completely, the status of the Li-ion batteries as the first energy source [102a] is determined to be non-functional. Thereafter, the sensor in the sticker [102e] of the bat [102] is powered by the solar battery power source [102b].

The invention further encompasses storing energy by the solar power battery source power source [102b] in a storage unit [102e] such as ultra-capacitors. This stored energy may then be used for at least one of to recharge the Li-ion batteries [102a] or provide power to the sensor in the sticker [102e].

Therefore, the present disclosure provides a reliable and long-lasting novel system for powering of embedded device [102] used at live event. The invention provides for a inventive mechanism for providing multiple energy sources for providing energy/power to the embedded device [102]. The one or more secondary energy sources can be used as a back-up for the primary energy source, when the primary energy source is completely discharged or non-operative/non-functional. The multiple one or more secondary energy sources can also be used to recharge the primary energy source. Further, the one or more secondary energy sources may be used to power the primary energy source as and when required. Hence, the invention discloses practical application of multiple energy sources to capture data at a live event.

While considerable emphasis has been placed herein on the disclosed embodiments, it will be appreciated that many embodiments can be made and that many changes can be made to the embodiments without departing from the principles of the present invention. These and other changes in the embodiments of the present invention will be apparent to those skilled in the art, whereby it is to be understood that the foregoing descriptive matter to be implemented is illustrative and non-limiting.

1. A system for powering at least one embedded device located at a live event for capturing data, the system comprising:
a first energy source configured to provide power to at least one component of the embedded device;
a second energy source, connected to the first energy source, configured to provide power to the at least one component of the embedded device, and
a processing unit configured to determine a status of the first energy source,
wherein,
the processing unit is further configured to automatically activate the second energy source to provide power to at least one component of the embedded device in an event the status of the first energy source is determined to be non-functional.

2. The system as claimed in claim 1, further comprising a storage unit to store energy from at least one of the first energy source and the second energy source.

3. The system as claimed in claim 1, further comprising a third energy source to power at least one component of the embedded device located at a live event.

4. The system as claimed in claim 1, wherein the processing unit is configured to determine the status of the first energy source to be non-functional based on the amount of energy in the first energy source, the time of the day, the operating status of the first energy source.

5. The system as claimed in claim 1, wherein the processing unit is configured to determine the status of the first energy source to be functional in an event at least one of the first energy source is operational and the first energy source is powering the at least one component of the embedded device.

6. The system as claimed in claim 1, wherein the first energy source and the second energy source is at least one of a Li-ion battery, a solar power source, a quartz battery power source.

7. The system as claimed in claim 1, wherein the processing unit is configured to determine the status of the first energy source dynamically or periodically.

8. The system as claimed in claim 1, wherein the first energy source and the second energy source are different.

9. The system as claimed in claim 2, wherein the processing unit is configured to recharge at least one of the first energy source and the second energy source by the energy stored in the storage unit.

10. The system as claimed in claim 1, wherein the second energy source is connected to the embedded device using a detachable connection.

11. A method for powering at least one embedded device located at a live event for capturing data, the method comprising:
identifying, by the processor unit, a first energy source to provide power to at least one component of the embedded device;
determining, by a processor unit, a status of the first energy source;
automatically activating, by the processor unit, a second energy source to provide power to at least one component of the embedded device in an event the status of the first energy source is determined to be non-functional;
powering, by the second energy source, the at least component of the embedded device.

12. The method as claimed in claim 10, further comprising storing by at least one of the first energy source and the second energy source, energy in a storage unit.

13. The method as claimed in claim 10, wherein the status of the first energy source is determined to be non-functional by the processing unit based on at least one of the amount of energy in the first energy source, the time of the day, the operating status of the first energy source.

14. The method as claimed in claim 10, wherein the status of the first energy source is determined to be functional by the processing unit in an event at least one of the first energy source is operational and the first energy source is powering the at least one component of the embedded device.

15. The method as claimed in claim 10, wherein the status of the first energy source is determined dynamically or periodically.

16. The method as claimed in claim 11, wherein the energy stored in the storage unit is used to recharge at least one of the first energy source and the second energy source by the processing unit.
